(19) United States
(12) Patent Application Publication
(10) Pub. No.: US 2014/0122130 A1
(43) Pub. Date: May 1, 2014

(54) SYSTEM AND METHOD FOR PREPARING VEHICLE REPAIR ESTIMATES AND SOURCING PARTS FOR VEHICLES

(71) Applicant: CCC INFORMATION SERVICES, INC., Chicago, IL (US)

(72) Inventors: John M. Kelly, Barrington, IL (US); David Douglas Boden, Manhattan Beach, CA (US); Ronald Nelson, Culver City, CA (US); Jesse Horski, Lakewood, CA (US); Sean Christopher FitzGerald, Del Aire, CA (US); Dhruv Bansal, Naperville, IL (US); Darrell K. Goodwin, La Verne, CA (US); Subrat Mishra, Mount Prospect, IL (US)

(73) Assignee: CCC INFORMATION SERVICES, INC., Chicago, IL (US)

(21) Appl. No.: 13/663,146

(22) Filed: Oct. 29, 2012

(51) Int. Cl. G06Q 10/00; G06Q 40/08

(52) U.S. Cl. 705/4; 705/305

(57) ABSTRACT

A system for preparing vehicle repair estimates and sourcing parts for vehicles includes a processor, a display in communication with the processor, and an input device in communication with the processor. The display is configured to display information generated by the processor, while the input device is configured to receive inputs from a user and transmit the inputs to the processor. The processor is configured to identify records in a first electronic database that relate to a particular vehicle, identify records in a second {or multiple} electronic database relating to a source of parts for the particular vehicle, display a repair estimate illustrating recommended parts and part sources on the display, and receive user input identifying parts other than recommended, or identifying a different source for a recommended part, and automatically updating the estimate and notification of guideline exceptions.

### BACKGROUND

1. Field of the Invention

The present invention generally relates to a system and method for preparing vehicle repair estimates and sourcing parts for vehicles.

2. Description of Related Art

Insurance adjusters and repair shops generally process a claim by performing a number of related tasks that include numerical cost estimates, information management, and communications between, for example, insurance company offices and employees in the field. The sum of tasks performed in claims processing define a workflow that must be accommodated in the insurance and automobile repair industries. Existing methods and systems for handling the repair of motor vehicles and insurance claims are typically limited to undertaking only one or a few of the daily tasks that make up insurance claim and repair workflow. For example, some methods are limited to calculation of a specific type of damage or injury and generating an estimate for repairing or replacing the damaged or injured item.

The calculation of a repair cost estimate is often done on a computer by entering reference data from external sources. The computer program may generate a numerical value as a result of looking at the data from the external sources and comparing it to the items that need to be replaced or repaired. In one estimating system, a vehicle claim estimate related to car panel and chassis damage is calculated and provided to a user. In another system, an auto body shop generates an estimate, including a digitized image of the vehicle that may be transmitted via modem to an insurance company. Other tasks necessary to vehicle repair and insurance claims processing, such as communication between an insurance company and repair facilities or managing of correspondence are typically handled separately.

The various available methods and systems for generating vehicle repair estimates are typically further limited to individual discrete calculations. After an appraiser prepares an estimate for repairing a vehicle, a separate calculation is often completed through a separate computer program to compute total loss valuation of a vehicle. Although these individual calculations may be obtained through separate programs, the results of each of the programs are difficult or awkward to compare because of the separate programs and data files involved.

Similarly, although separate methods and systems for performing some of the administrative tasks in vehicle repair and insurance claim processing workflow are available, each of these separate computer programs requires certain types of data and each outputs a certain type of data. The data required for the separate programs may overlap and lead to redundant data entry tasks being performed. Data sharing between the different, discrete methods and systems that an insurance company uses may be difficult due to incompatible data formats. Therefore, a claim adjuster must spend time keeping track of, and running, the separate programs. Appraisers, repair shops, and others involved in claim processing often need to switch between, and learn how to operate, separate software programs having separate data and interface requirements. Present methods of handling insurance claims not only tend to require the use of separate software and hardware tools for various calculations, but also require separate organization of administrative material and client mailings to the insured party.

Insurance companies and other parties involved in the claims process often juggle many separate computer files and pieces of paper generated for each claim.

### SUMMARY

In satisfying the above need, as well as overcoming the enumerated drawbacks and other limitations of the related art, the present invention provides a system and method for preparing vehicle repair estimates and sourcing parts for vehicles. The system includes a processor, a display in communication with the processor, and an input device in communication with the processor.

The display is configured to display information generated by the processor, while the input device is configured to receive inputs from a user and transmit the inputs to the processor. The processor is configured to identify records in a first electronic database that relate to a particular vehicle, identify records in a second (or more) electronic database relating to a source of parts for the particular vehicle, display a repair estimate illustrating recommended parts and part sources on the display, guidelines if a non-recommended part has been selected, and receive user input identifying parts other than recommended, or identifying a different source for a recommended part, and automatically updating the estimate.

The records in the first electronic database may contain data relating to parts of the particular vehicle and/or records of vehicles manufactured by a plurality of manufacturers. The records in the second electronic database may contain data on currently available parts for the particular vehicle from a plurality of different sources including at least an original equipment manufacturer, an aftermarket parts source, a reconditioned parts source, or a recycled parts source. The repair estimate may be modified by a user using the input device of the computer to utilize parts from a different source. The estimate is then automatically updated when the user utilizes parts from the different source.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a block diagram of the system for preparing vehicle repair estimates and sourcing parts for vehicles;

FIG. 2 illustrates a method for preparing vehicle repair estimates and sourcing parts for vehicles;

FIG. 3 illustrates a method for displaying a vehicle repair estimate;

FIG. 4 illustrates a method for receiving authorization to utilize parts from a non-preferred vendor;

FIG. 5 illustrates a screen shot provided to a display for the system for preparing vehicle repair estimates and sourcing parts for vehicles;

FIG. 6 illustrates a screen shot illustrating each part inventor information for each part;

FIG. 7 illustrates a screen shot displaying vendor information;

FIG. 8 illustrates a screen shot describing part information;

FIG. 9 illustrates a screen shot displaying a vendor parts mix;

FIG. 10 illustrates a screen shot displaying another view of the vendor parts mix;

FIG. 11 illustrates a screen shot displaying part information; and

FIG. 12 illustrates a screen shot displaying an exceptions part list.

### DETAILED DESCRIPTION

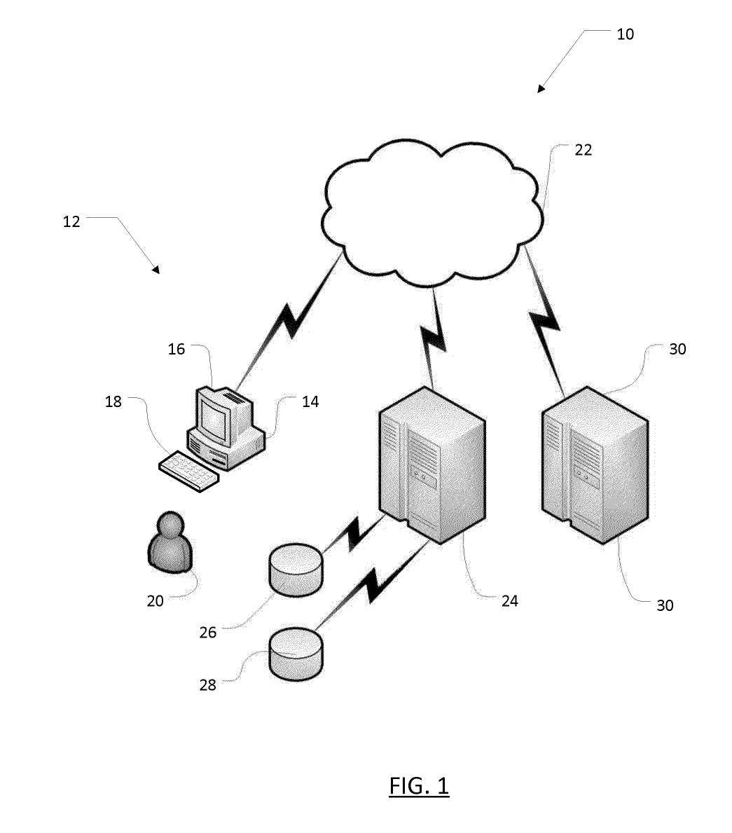

Referring to FIG. 1, a system 10 for preparing vehicle repair estimates and sourcing parts for vehicles is shown. The system 10 generally includes a computer system 12. The computer system 12 includes a processor 14 in communication with a display device 16 and an input device 18. The computer system 12 may be a dedicated device or may be a general purpose computer. The input device 18 may take any one of variety of suitable forms for receiving input from a user 20. As such, the input device 18 may be a keyboard, as shown, or could be a pointing device, such as a mouse, a voice activated device or any device capable of receiving input from a user 20. The computer system 12 may be in communication with a network 22. The network 22 may be an internal network or could possible include a distributed network, such as the internet. Further, the network 22 may be as a direct connection between the system 12 and other computing devices.

The system 10 may also include a server 24 that is in communication with a first database 26 and a second database 28. The first and second databases 26 and 28 may be directly connected to the server 24 or may be connected through a network to the server 24. The databases 26 and 28 can be stored in a variety of different mediums including magnetic, optical, and solid state devices. However, it should be understood that any suitable storage medium may be used to store the first and second databases 26 and 28. Further, the first and second databases 26 and 28 may each be stored in a single database or combined together or even stored across a variety of different databases in different locations and connected to the server 24 through a variety of suitable ways.

The records in the first database 26 may contain data relating to the parts of a particular vehicle and having records of vehicles manufactured by a plurality of different vehicle manufacturers. The records in the second database 28 may contain data on currently available parts for a particular vehicle from a plurality of different sources including at least one of an original equipment manufacturer, an aftermarket parts source, a reconditioned parts source, and/or a recycled parts source. The data contained in the databases 26 and 28 may be updated via the server 24 by either providing information directly to the server 24 or by the server 24 communicating with other computers via the network 22. This updating may occur instantly as the information changes or may occur on a periodic basis.

The system 10 may also include another server 30. The server 30 may be a server operated by a third party, such as a parts supplier. As will be explained in more detail later, request for inclusion of parts to the third party server 30 can be transmitted from the system 12 to the server 30 via the network 22. The server 30 can provide authorization to utilize parts from a non-preferred vendor.

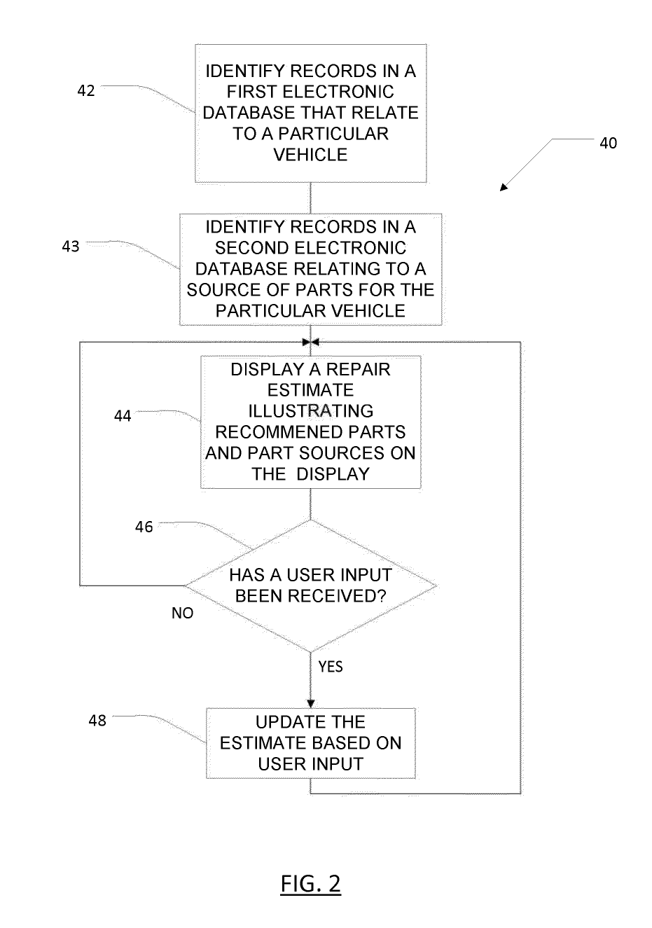

Referring to FIG. 2, a method 40 for preparing vehicle repair estimates and sourcing parts for vehicles is shown. In describing the method 40, reference will also be made to FIG. 1 as well. The method 40 may be executed by the system 12 or the server 24. In either case, the processor 14 of the system 12 or the processor of the server 24 will execute the method 40. In step 42, records are identified in the first electronic database 26 that relate to a particular vehicle. As stated before, the records in the first database 26 may contain data relating to the parts of a particular vehicle and the first database 26 may have records of vehicles manufactured by a plurality of manufacturers. In step 43, the processor identifies records in the second database 28 relating to a source of parts for the vehicle. More simply, the user 20 will provide vehicle identification and then parts relating to the vehicle identified are identified. In step 44, a part comparison screen illustrating recommended parts and the parts sources are displayed on the display 16 of the system 12.

In step 46, a determination is made that the user input identifying parts other than recommended, or identifying a different source for a recommended part is determined. If this has occurred, the estimate is automatically updated. Further, the repair estimate can be modified by the user 20 using the input device 18 to utilize parts from a different source and then automatically updates the estimate when the user 20 utilizes parts from the different source, as illustrated in step 48.

The server 24 recommends parts by reducing the total universe of eligible parts based off filtering rules and ranking criteria ensuring that the appropriate types of parts are used with consideration for availability, price, and other customizable criteria. For example, if there is a rule that says use OEM parts to replace an airbag that ensures higher safety on the vehicle. If 10 airbags are returned by the server 24, the user must still decide which is the best given a number of criteria.

Further, the server 24 may further support a “best part” selection. This functionality enables the server 24 to select a single part as best meeting the logic defined in the sourcing rules. The user may still be able to view the other available parts; however, the server 24 may utilize rules based intelligence to select the best parts without human interaction or choice.

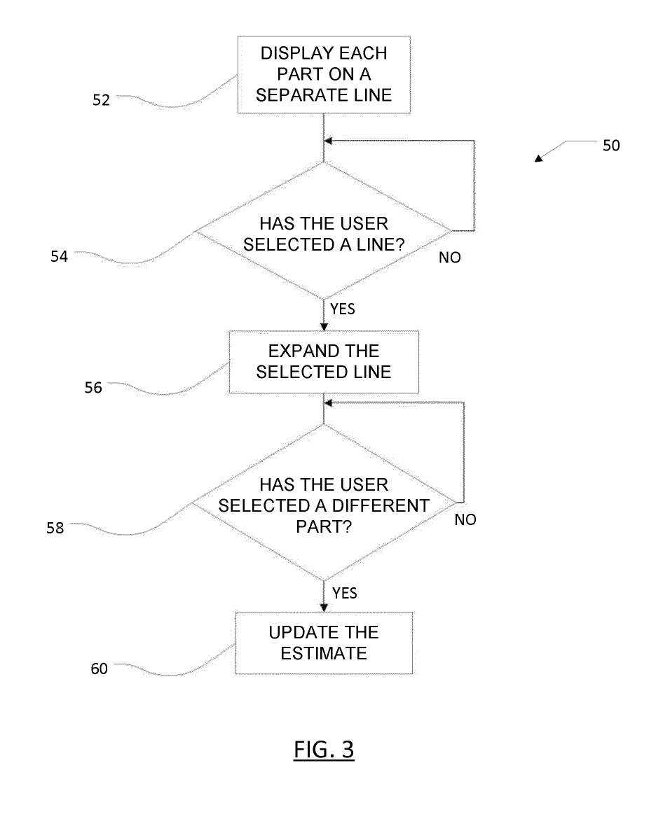

Referring to FIG. 3, a more detailed method 50 describing step 44 of FIG. 2 is shown. In describing the method 50, reference will also be made to FIG. 1 as well. In step 52, each part is displayed on a separate line on the display device 16. In step 54 a determination is made that the user 20 selected a line using the input device 18. If this has occurred, in step 56 the line is expanded for each part of the estimate to allow the user 20 using the input device 18 to select the source of the part, as shown in step 58. If the user had selected a different part, the estimate is updated as shown in step 60.

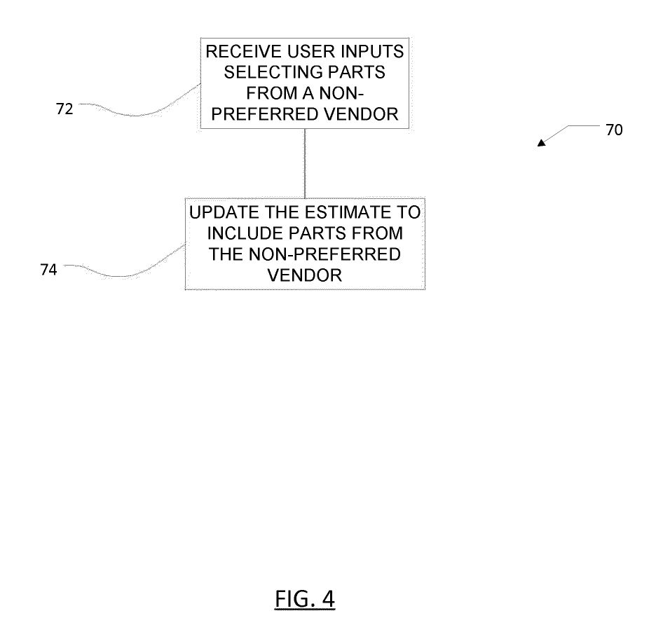

Referring to FIG. 4, a method 70 shows that there may be communication with the server 30 operated by a third party. In step 72, the system receives user input selecting parts from a non-preferred vendor. Finally, in step 74, the estimate may be updated to include parts from the non-preferred vendor.

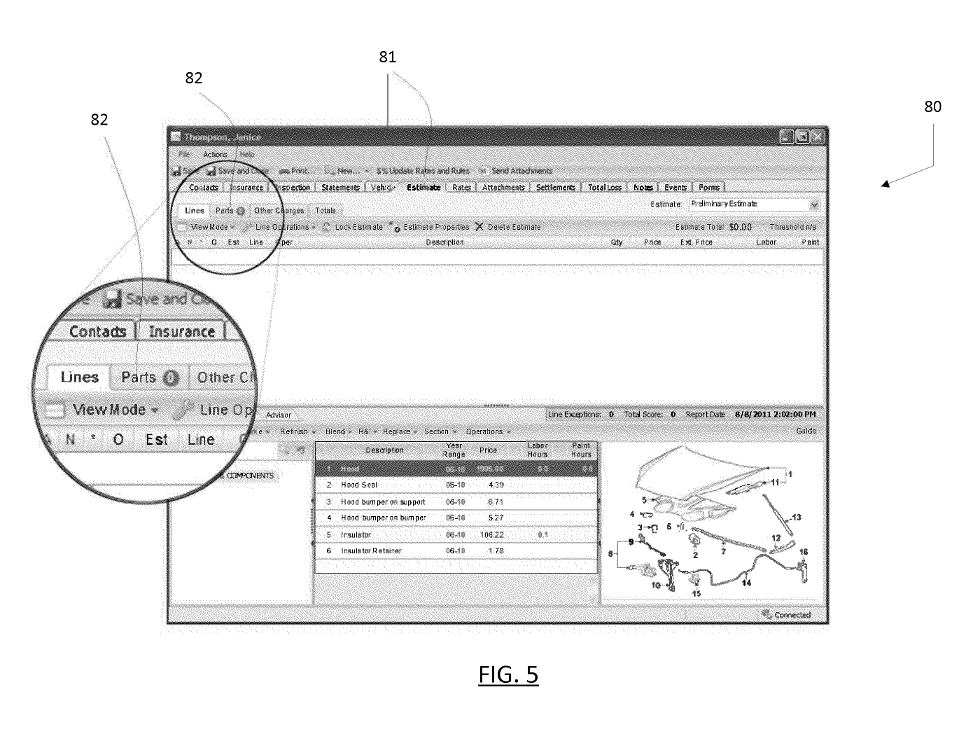

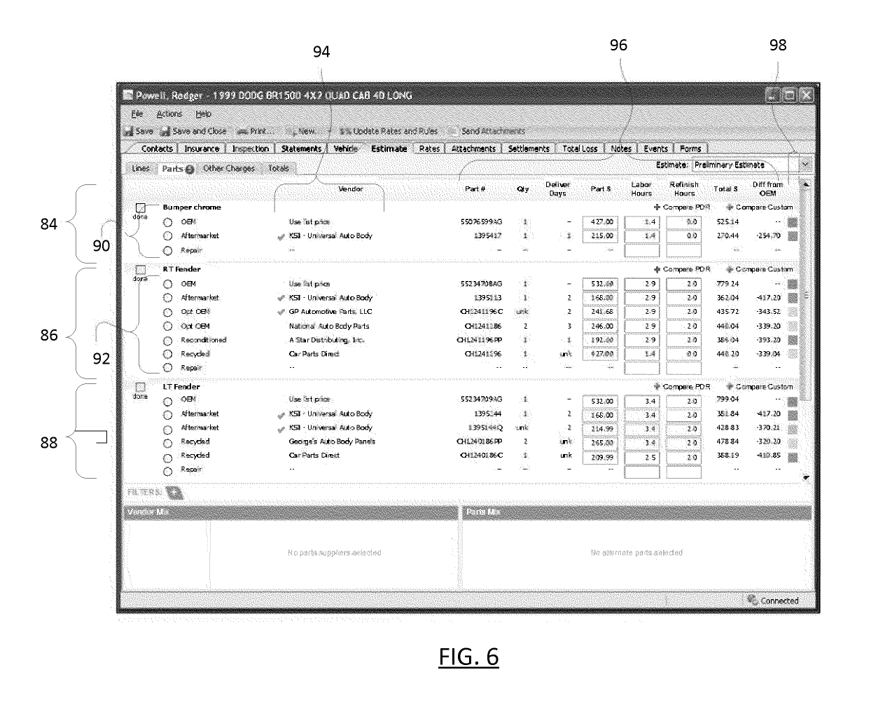

Referring to FIG. 5, a screen shot 80 which may be displayed on the display device 16 of the system 12 of FIG. 1 is shown. The screen shot 80 includes an estimate tab 81 which may also have a parts tab 82. When the user 20 selects the parts tab 82 a more detailed view of the parts displayed is shown, as best shown in FIG. 6 and as previously described by method 50 of FIG. 3. In FIG. 6, different parts are shown. In this example, a bumper 84, a right fender 86, and a left fender 88 are shown. Below the bumper 84 are shown three choices for selecting different bumper options.

In this case, selections regarding original equipment manufacturer, aftermarket, and recycled repair parts are shown. With regards to the right fender 86, even more choices are shown including reconditioned parts, recycled parts, and optional original equipment manufacturer parts. In both cases, a vendor column 94 is shown describing different vendors for each of the different part sources. Additional information in columns 96 are shown and may include part number, quantity on hand, days until delivery, the price of the part, labor hours, refinishing hours, total price, and price difference from the original equipment manufacturer. There may also be an additional column indicating the price difference from the original equipment manufacturer price utilizing a color or symbol, as shown in column 98. Also, an indicator indicating the best part match for a singular part, a quote or a quote expiration date for a given part price may be displayed.

Further, a recommendation may be displayed to recommend a recycled assembly to in place of a collection of related parts. Alternatively or additionally, a rule may recommend a collection of related part lines in place of a recycled assembly.

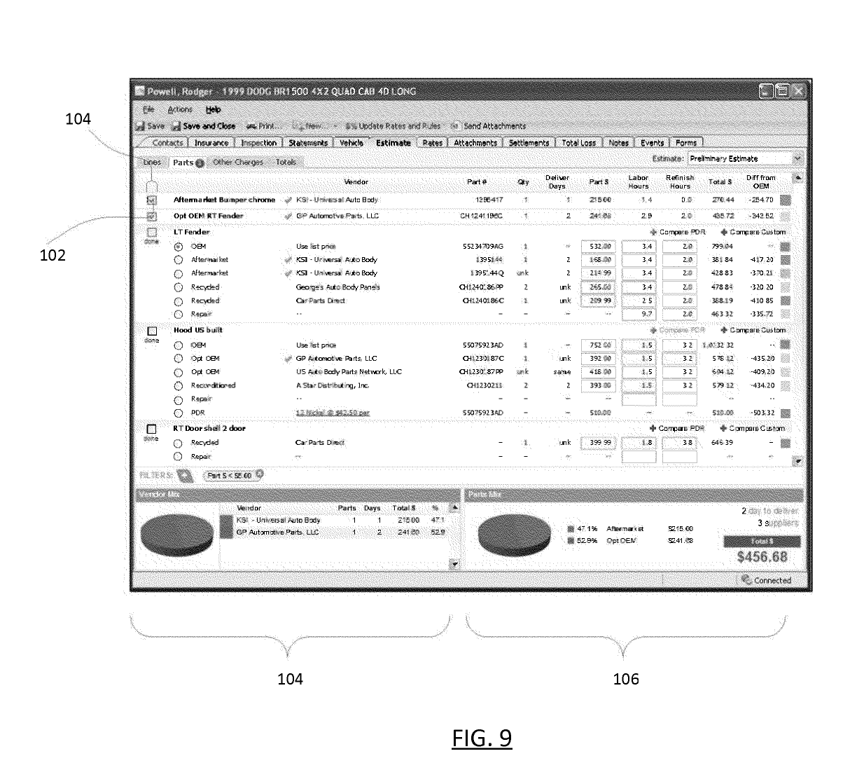

Additionally or alternatively, the information displayed in FIG. 9 may be filtered based off rules down to a more precise number of parts—as low as five parts, three parts, or even a single part. If a single part match is identified, an automatic selection of the part replace is performed.

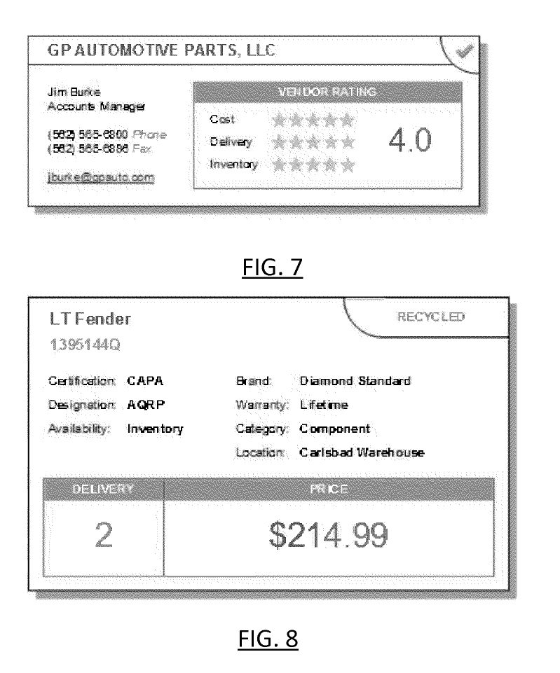

Referring to FIGS. 7 and 8, the user 20 of the system 12 may also be able to select information regarding the vendor for the part itself. More specifically, FIG. 7 illustrates what may be displayed on a display device 16 of the system 12 when a user selects information relating to the vendor. In this example, the vendor's name, telephone number, and rating information regarding cost, delivery, and/or inventory is shown. In FIG. 8, information regarding a part is shown including the part number, certification, designation, inventory, brand, warranty, category, and/or location.

Referring to FIG. 9, a screen shot is shown regarding what occurs when the done column 100 is selected. As a user 20 goes through each of the parts and selects an appropriate source and vendor of the parts, the user 20 afterwards selects the done box 102 in the column 100. The system may then display vendor mix information 104 either visually or numerically and may further display parts mix information 106 either visually or numerically. The vendor mix information includes what percentage and what total amount is spent per vendor. The parts mix information gives a breakdown by percentage and amount regarding the type of source of the parts.

The system 12 may also further display on the display device a difference in price between a current estimate part and an estimate from another source of the part. This system may also display a repair estimate on a separate line, wherein a repair estimate uses approved parts and part sources based on a list of rules generated by an insurance company to utilize preferred parts from preferred sources. The system may also determine if the user has selected an override command by selecting the separate line, wherein the override command allows the user to select different parts from different sources. By so doing, the user can simply accept what the insurance company has provided or it can override the insurance company recommendation and utilize parts from different sources. The system may also display guideline information explaining to the user the changes required in an estimate to make the estimate compliant with the rules of an insurance company. Further, the system may further comprise comparing the cost of repair, refinish, paintless dent repair, sublet operations, and/or replace operations

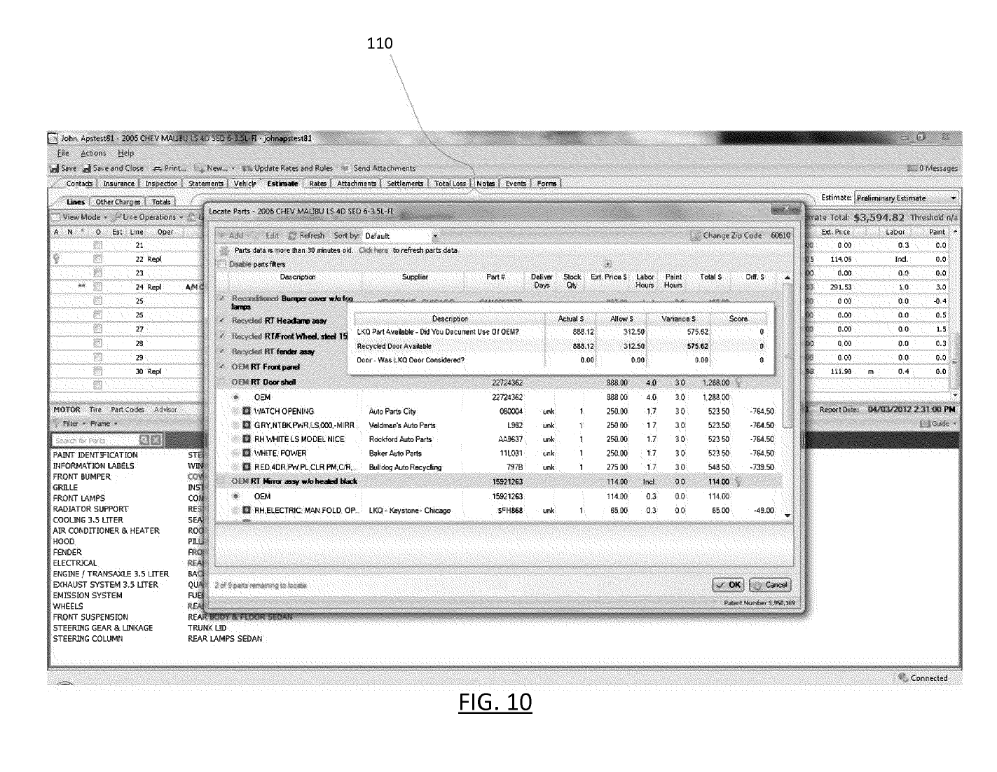

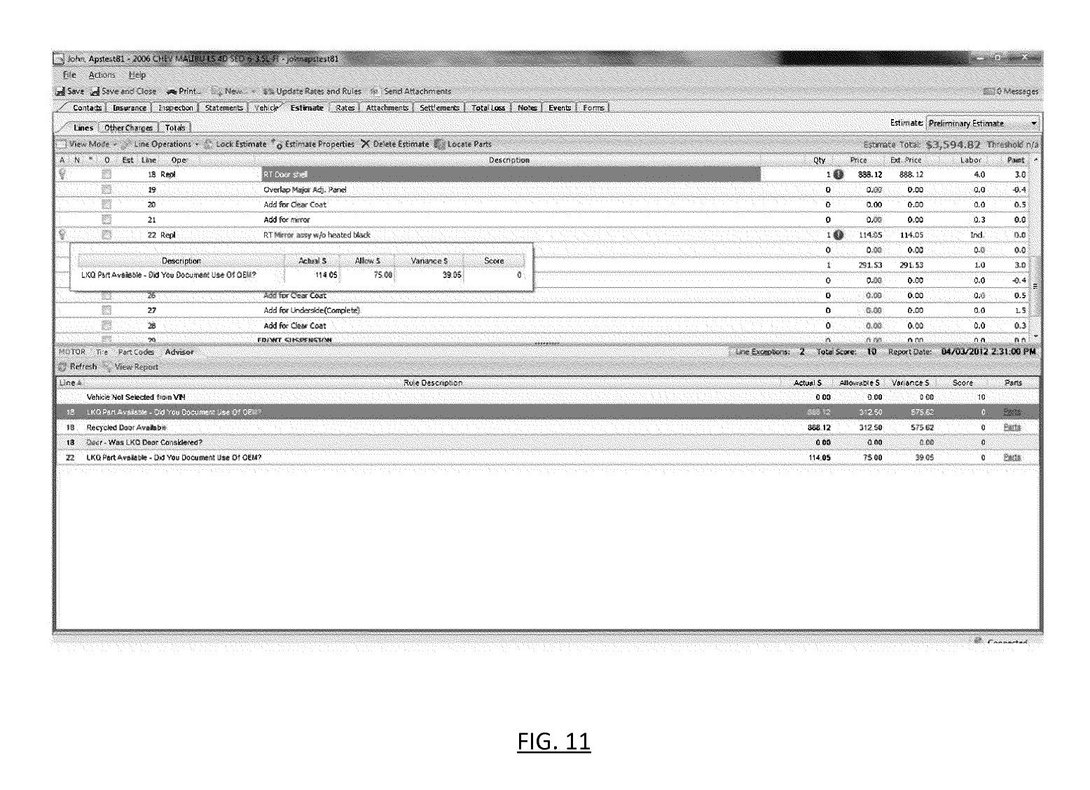

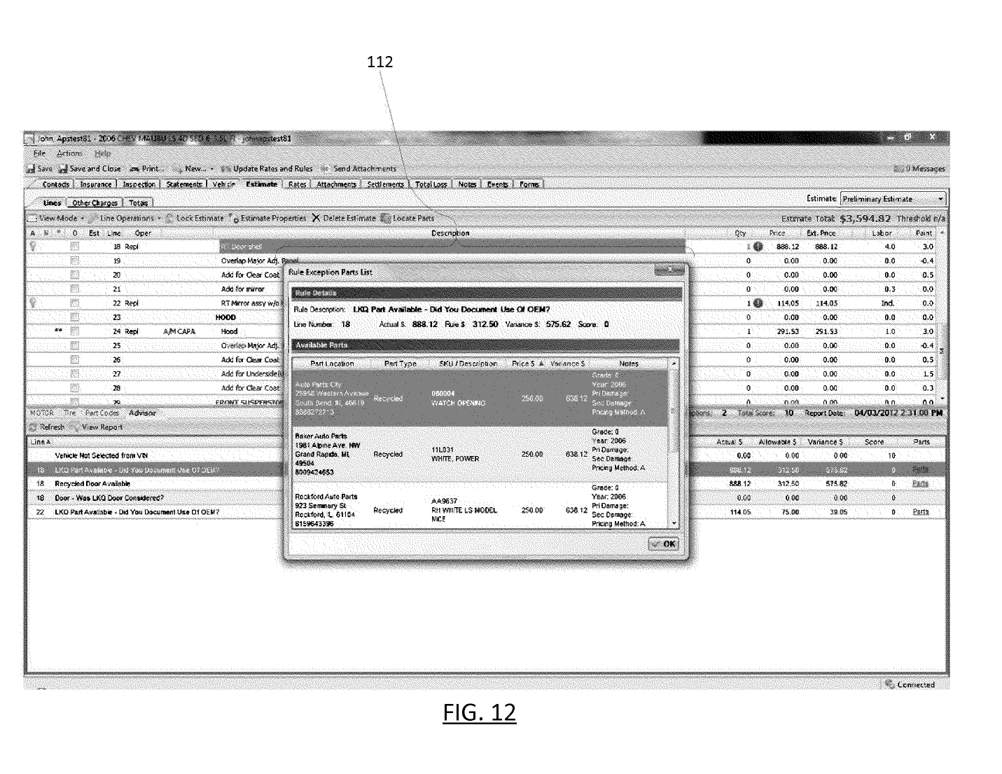

Referring to FIG. 10, another example is shown. In this example, a screen shot of a window 110 is shown. The window 110 is similar to the window shown in FIG. 6 in that it provides similar information but does so in a different manner. More specifically, the window 110 provides a separate interface where the user can change and select different parts from the part database. Once the user selects different parts from the part database in FIG. 10, the corresponding estimate can be updated as shown in FIG. 11. Finally, in FIG. 12, a rules exception part list can be displayed showing exception to the insurance company rules of different parts. This can provide an additional window to allow the user to confirm that the user wishes to select parts that are noted on the exceptions list and would not normally be allowed by an insurance company. This provides an easy check for the user to change the part list if necessary.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A method for preparing vehicle repair estimates and sourcing parts for vehicles in a computer system having a processor and a display, the method comprising the steps of:
identifying records in a first electronic database that relate to a particular vehicle, the records in the first electronic database containing data relating to parts of the particular vehicle, the first electronic database having records of vehicles manufactured by a plurality of manufacturers;
identifying records in a second electronic database relating to a source of parts for the particular vehicle, the records in the second electronic database containing data on currently available parts for the particular vehicle from a plurality of different sources including at least an original equipment manufacturer, an aftermarket parts source, a reconditioned parts source, and a recycled parts source;
displaying a repair estimate illustrating recommended parts and part sources on the display;
receiving user input identifying parts other than recommended, or identifying a different source for a recommended part, and automatically updating the estimate; and
wherein the repair estimate can be modified by a user using the input device of the computer to utilize parts from a different source and automatically updating the estimate when the user utilizes parts from the different source.

2. The method of claim 1, wherein displaying the repair estimate comprises displaying each part on a separate line and wherein the method further comprises:
expanding a line when selected by the input device for each part of the estimate to allow the user using the input device of the computer to select the source of the part; and
automatically updating the estimate when the user selects parts from the different source.

3. The method of claim 2, further comprising displaying vendor information of the source when the line of the estimate is expanded when selected by the input device.

4. The method of claim 3, wherein the vendor information includes at least one of a vendor name and a preferred vendor indication.

5. The method of claim 4, further comprising:
receiving user inputs selecting parts from a non-preferred vendor;
transmitting a request for approval to a third party when receiving user inputs selecting parts from a non-preferred vendor;
receiving authorization from the third party to utilize parts from a non-preferred vendor; and
updating the estimate to include parts from the non-preferred vendor.

6. The method of claim 2, further comprising displaying a difference in price between a current estimate and an estimate from another source of a part.

7. The method of claim 6, further comprising displaying on the display device a color or symbol indicating the difference in price between the original equipment part and the price from another source of a part

8. The method of claim 1, further comprising displaying on the display device a visual representation of the percentage of parts coming from different vendors based on the prices of the parts.

9. The method of claim 1, further comprising displaying on the display device a visual representation of the percentage of parts coming from different parts sources based on the prices of the parts.

10. The method of claim 1, wherein prior to displaying the repair estimate illustrating recommended parts and part sources automatically filtering which types of parts are displayed and which part sources are initially displayed selected based on a list of rules generated by an insurance company to utilize preferred parts from preferred sources and automatically initially displaying the estimate utilizing the preferred parts from the preferred sources.

11. The method of claim 1, wherein the method further comprises:
displaying the repair estimate on a separate line, wherein the repair estimate uses approved parts and part sources based on a list of rules generated by an insurance company to utilize preferred parts from preferred sources; and
determining if the user has selected an override command by selecting the separate line, wherein the override command allows the user to select different parts from different part sources.

12. The method of claim 1, wherein the method further comprises displaying guideline information explaining the changes required in an estimate to make the estimate compliant with rules of an insurance company.

13. The method of claim 1, wherein the method further comprises comparing cost of repair, refinish, and sublet operations to replace operations.

14. The method of claim 1, wherein the method further comprises displaying inventory.

15. The method of claim 1, wherein the method further comprises displaying a quote or a quote expiration date for a given part price.

16. The method of claim 1, wherein the method further comprises displaying a recommendation to recommend a recycled assembly to in place of a collection of related parts.

17. The method of claim 1, wherein the method further comprises displaying a recommendation to recommend a collection of related part lines in place of a recycled assembly.

18. A system for preparing vehicle repair estimates and sourcing parts for vehicles, the system comprising:
a processor;
a display in communication with the processor, the display configured to display information generated by the processor;
an input device in communication with the processor, the input device configured to receive inputs from a user and transmit the inputs to the processor;
the processor being configured to:
identify records in a first electronic database that relate to a particular vehicle, the records in the first electronic database containing data relating to parts of the particular vehicle, the first electronic database having records of vehicles manufactured by a plurality of manufacturers;
identify records in a second electronic database relating to a source of parts for the particular vehicle, the records in the second electronic database containing data on currently available parts for the particular vehicle from a plurality of different sources including at least an original equipment manufacturer, an aftermarket parts source, a reconditioned parts source, and a recycled parts source;
display a repair estimate illustrating recommended parts and part sources on the display;
receive user input identifying parts other than recommended, or identifying a different source for a recommended part, and automatically updating the estimate; and
wherein the repair estimate can be modified by a user using the input device of the computer to utilize parts from a different source and automatically updating the estimate when the user utilizes parts from the different source.

19. The system of claim 18, wherein the processor is further configured to:
expand a line when selected by the input device for each part of the estimate to allow the user using the input device of the computer to select the source of the part; and
automatically update the estimate when the user selects parts from the different source.

20. The system of claim 19, wherein the processor is further configured to display on the display device vendor information of the source when the line of the estimate is expanded when selected by the input device.

21. The system of claim 20, wherein the vendor information includes at least one of a vendor name and a preferred vendor indication.

22. The system of claim 21, wherein the processor is further configured to:
receive user inputs selecting parts from a non-preferred vendor;
transmit a request for approval to a third party when receiving user inputs selecting parts from a non-preferred vendor;
receive authorization from the third party to utilize parts from a non-preferred vendor; and
update the estimate to include parts from the non-preferred vendor.

23. The system of claim 19, wherein the processor is further configured to display a difference in price between a current estimate part estimate and from another source of a part.

24. The system of claim 23, wherein the processor is further configured to display on the display device a color or symbol indicating the difference in price between the original equipment part and the price from another source of a part.

25. The system of claim 18, wherein the processor is further configured to display on the display device a visual representation of the percentage of parts coming from different vendors based on the prices of the parts.

26. The system of claim 18, wherein the processor is further configured to display on the display device a visual representation of the percentage of parts coming from different sources based on the prices of the parts.

27. The system of claim 18, the wherein prior to displaying the repair estimate illustrating recommended parts and part sources automatically filtering which types of parts are displayed and which part sources are initially displayed selected based on a list of rules generated by an insurance company to utilize preferred parts from preferred sources and automatically initially displaying the estimate utilizing the preferred parts from the preferred sources.

28. The system of claim 18, wherein the processor is further configured to:
display the repair estimate on a separate line, wherein the repair estimate uses approved parts and part sources based on a list of rules generated by an insurance company to utilize preferred parts from preferred sources; and
determine if the user has selected an override command by selecting the separate line, wherein the override command allows the user to select different parts from different part sources.

29. The system of claim 18, wherein the wherein the processor is further configured to display guideline information explaining the changes required in an estimate to make the estimate compliant with rules of an insurance company.

30. The system of claim 18, wherein the processor is further configured to compare cost of repair, refinish, and sublet operations to replace operations.

31. The system of claim 18, wherein the processor is further configured to display inventory.

32. The system of claim 18, wherein the processor is further configured to display a quote or a quote expiration date for a given part price.

33. The system of claim 18, wherein the processor is further configured to display a recommendation to recommend a recycled assembly to in place of a collection of related parts.

34. The system of claim 18, wherein the processor is further configured to display a recommendation to recommend a collection of related part lines in place of a recycled assembly.
